(19) United States
(12) Patent Application Publication
(10) Pub. No.: US 2025/0355276 A1
(43) Pub. Date: Nov. 20, 2025

(54) APPARATUS AND METHOD FOR MEASURING CENTER DEVIATION OF CONTACT LENS USING ARTIFICIAL INTELLIGENCE

(71) Applicant: CHUNGBUK NATIONAL UNIVERSITY INDUSTRY-ACADEMIC COOPERATION FOUNDATION, Chungcheongbuk-do (KR)

(72) Inventors: Gi Nam KIM, Chungcheongbuk-do (KR); Kwan Hee YOO, Daejeon (KR)

(21) Appl. No.: 18/788,744

(22) Filed: Jul. 30, 2024

(30) Foreign Application Priority Data
May 17, 2024 (KR) 10-2024-0064195

(51) Int. Cl. G02C 7/04; G02C 7/02

(52) U.S. Cl. CPC G02C 7/047; G02C 7/028

(57) ABSTRACT

An apparatus for measuring a center deviation of a contact lens includes a data augmentation unit configured to augment original contact lens image data photographed during a contact lens manufacturing process, an artificial intelligence learning unit configured to use a dataset augmented by the data augmentation unit as an input to conduct learning through an artificial intelligence learning model, and detect a center point of a colored area and a center point of a frame area of the contact lens through learning, and a measuring unit configured to measure the center deviation using the center point of the colored area and the center point of the frame area detected through the artificial intelligence learning model in the artificial intelligence learning unit. There is an effect of quickly and accurately detecting an off-center defect of a contact lens, thereby reducing a defect rate and increasing production efficiency.

### CROSS-REFERENCE TO RELATED APPLICATION

This application claims priority to Korean Patent Application No. 10-2024-0064195 filed on May 17, 2024 and all the benefits accruing therefrom under 35 U.S.C. § 119, the contents of which are incorporated by reference in their entirety.

### BACKGROUND

The present disclosure relates to a technology for measuring a center deviation of a contact lens using artificial intelligence.

Digital transformation (DX) is bringing a fundamental change to the modern industrial structure. This revolutionary change is fueled by the rapid development of information technology (IT) and advances in data analysis technology, redefining existing work methods and processes in various industrial fields. Among them, the concept of smart factory plays a particularly important role in manufacturing. The smart factory is dramatically improving product quality, productivity, and cost efficiency, and revolutionizing traditional manufacturing methods by automating and optimizing manufacturing processes by integrating the latest technologies such as the Internet of Things (IoT), big data, artificial intelligence (AI), and the like.

The core of the smart factory lies in data-based decision-making and process optimization. For this purpose, technologies such as advanced data analytics, predictive modeling, real-time monitoring, and the like, are being utilized. For example, an automatic defect inspection system utilizing an image processing technology plays an important role in continuously monitoring product quality and quickly identifying and eliminating defective products. Advances in a smart factory technology contribute to strengthening quality control in the manufacturing process, reducing defect rates, and increasing the reliability of final products.

Even in the contact lens manufacturing field, the importance of quality control is emphasized as the product comes in direct contact with the eyes. The contact lens manufacturing field is a field greatly affected by digital transformation.

Among the contact lens manufacturing processes, a sandwich method is a production method that puts dye between lens layers for coloring. Typical defects in manufacturing using the sandwich method are as follows.

FIG. 1 is a view showing an example of a normal colored contact lens product.

FIG. 2 is a view showing an example of poor coloration of a colored contact lens. Poor coloration occurs when even one layer is not colored during a multi-layer coloring process.

FIG. 3 is a view illustrating a line defect in a colored contact lens. The line defect occurs when a line object occurs due to scratches during the coloring process.

FIG. 4 is a view showing an example of an off-center defect of a colored contact lens.

Referring to FIG. 4, a red circle a is a colored area (CA), and a blue circle b is a frame area (FA). The off-center defect refers to a case where the colored area deviates from the center point.

FIG. 5 is a view showing an example of a halftone dot defect in a colored contact lens. The halftone dot defect occurs when some of halftone dots are lost.

FIG. 6 is a view showing an example of cosmetic cutting of a colored contact lens. The cosmetic cutting occurs when the colored area is not partially colored.

FIG. 7 is a view showing an example of non-molding defect of a colored contact lens. The non-molding defect is a defect in which part of the lens is not molded.

FIG. 8 is a view showing an example of a crack defect in a colored contact lens. The crack defect is a defect in which the inside or edge of the lens is broken.

FIG. 9 is a view showing an example of a foreign matter defect in a colored contact lens. The foreign matter defect is a defect that occurs when foreign matter enters the lens.

FIG. 10 is a view showing an example of a bubble defect in a colored contact lens. The bubble defect is a defect that occurs when bubbles form in the lens during molding.

FIG. 11 is a view showing an example of a dust defect in a colored contact lens. The dust defect is a defect caused by dust during molding.

FIG. 12 is a view showing an example of a printing defect in a colored contact lens. The printing defect is a defect in which part of an iris image is not printed.

Among the defects of the contact lens, the off-center defect goes beyond simple determination of the defect and requires precise measurement of the extent of deviation from the center point. The measurement makes it possible to properly print at the center point through position adjustment of printing equipment. The center deviation (CD) measurement is performed using the following equation.

$${CD}_{x} = \vert {x}_{FA} - {x}_{CA} \vert \\ {CD}_{y} = {\vert {y}_{FA} - {y}_{CA} \vert}_{**} \qquad ( 1 )$$

Here, (x_{CA}, y_{CA}) represents the center point of a colored area (CA), and (x_{FA}, y_{FA}) represents the center point of a frame area (FA).

As described above, since contact lenses are products that come in direct contact with the eyes, even minor defects may have a significant impact on the user's eye health and comfort. Therefore, manufacturers apply strict quality standards, and a detailed inspection process is essential to meet the quality standards. Currently, when a defect occurs during the contact lens production process, all defects produced in the relevant facility over a certain period of time are discarded, which increases production costs and causes quality to deteriorate.

The existing technology for determining whether a contact lens is defective has the following limitations.

First, as a limitation in determining whether a contact lens is defective, existing methods have suggested a classification model for all defect types, including non-defective products and off-center defects, but the methods cannot measure the center deviation (CD), making detailed adjustment of printing equipment difficult.

Second, as a limitation of data augmentation, existing data augmentation methods have used traditional methods such as color conversion, position conversion, and image rotation, but the methods do not overcome the limitation of fixed printing patterns, and may cause overfitting, especially for lens types for which there is insufficient data.

Third, as a computing resource consumption issue, existing technologies consume a significant amount of computing resources since the technologies use image segmentation and Hough circle detection together.

Fourth, as a limitation of accuracy, in the existing technology, an error of 2.902 pixels occurs in a 512×512-pixel image between a predicted value and an actual value, and there is a need to improve accuracy further.

Examples of the related art include Korean Patent Registration No. 10-2504785.

### SUMMARY

The present disclosure has been made in order to resolve the above limitations, and provides an apparatus and method for measuring a center deviation of a contact lens using artificial intelligence, capable of reducing a defect rate and increasing production efficiency by quickly and accurately detecting and measuring an off-center defect of a contact lens.

Aspects of the present disclosure are not limited to the above, and other aspects not mentioned will be clearly understood by those skilled in the art from the description below.

In accordance with an exemplary embodiment, an apparatus for measuring a center deviation of a contact lens includes a data augmentation unit configured to augment original contact lens image data photographed during a contact lens manufacturing process, an artificial intelligence learning unit configured to use a dataset augmented by the data augmentation unit as an input to conduct learning through an artificial intelligence learning model, and detect a center point of a colored area and a center point of a frame area of the contact lens through learning, and a measuring unit configured to measure the center deviation using the center point of the colored area and the center point of the frame area detected through the artificial intelligence learning model in the artificial intelligence learning unit.

The data augmentation unit may augment the original contact lens image data using a diffusion model.

The data augmentation unit may augment the original contact lens image data using a denoising diffusion probabilistic model (DDPM).

The artificial intelligence learning unit may proceed with learning using an object detection model.

The artificial intelligence learning unit may conduct learning using an asymmetric convolution-you only look once (AC-YOLO) model that applies an asymmetric convolutional neural network.

In accordance with another exemplary embodiment, a method for measuring a center deviation of a contact lens in an apparatus for measuring a center deviation of a contact lens includes a data augmentation step of augmenting original contact lens image data photographed during a contact lens manufacturing process, an artificial intelligence learning step of using a dataset augmented in the data augmentation step as an input to conduct learning through an artificial intelligence learning model and detecting a center point of a colored area and a center point of a frame area of the contact lens through learning, and a measurement step of measuring the center deviation using the center point of the colored area and the center point of the frame area detected through the artificial intelligence learning model in the artificial intelligence learning step.

In the data augmentation step, the original contact lens image data may be augmented using a diffusion model.

In the data augmentation step, the original contact lens image data may be augmented using a denoising diffusion probabilistic model (DDPM).

The artificial intelligence learning step, learning may be conducted using an object detection model.

In the artificial intelligence learning step, learning may be conducted using an asymmetric convolution-you only look once (AC-YOLO) model that applies an asymmetric convolutional neural network.

### BRIEF DESCRIPTION OF THE DRAWINGS

Exemplary embodiments can be understood in more detail from the following description taken in conjunction with the accompanying drawings, in which:

FIG. 1 is a view showing an example of a normal colored contact lens product;

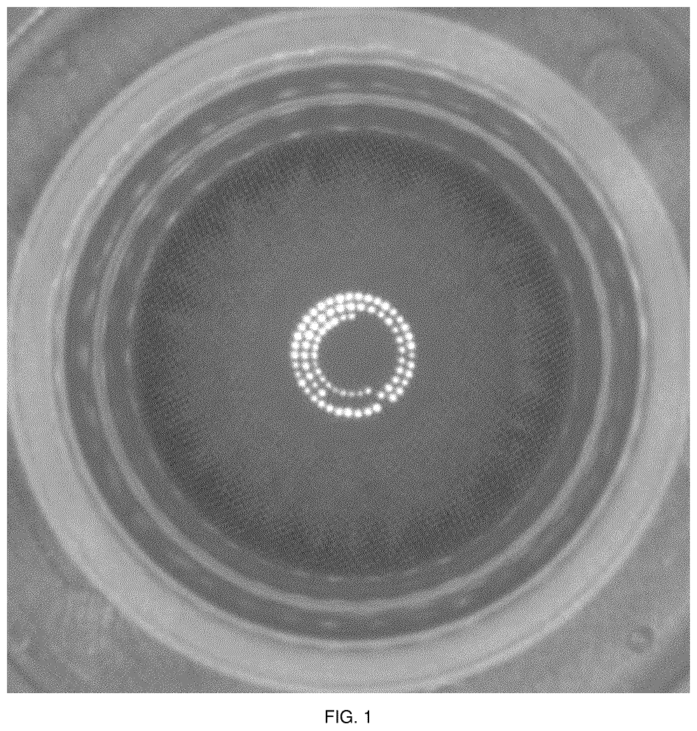

FIG. 2 is a view showing an example of poor coloration of a colored contact lens;

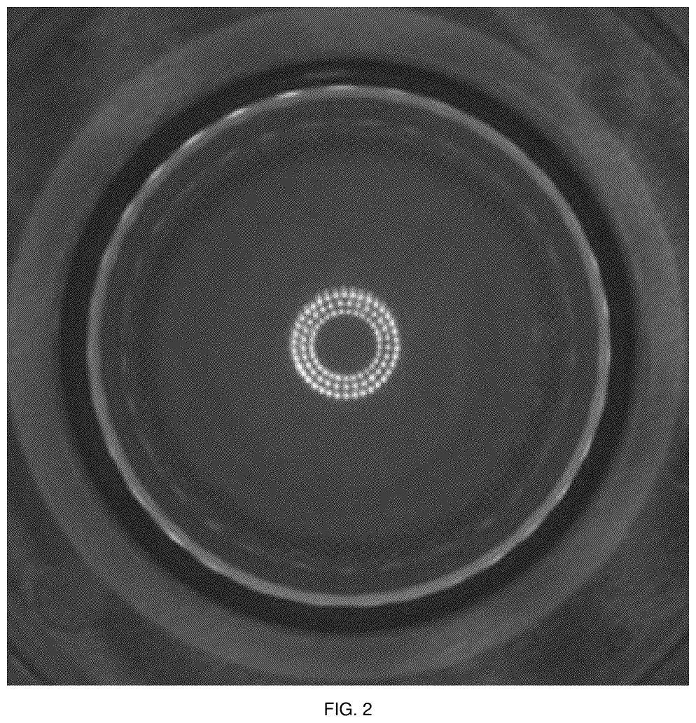

FIG. 3 is a view illustrating a line defect in a colored contact lens;

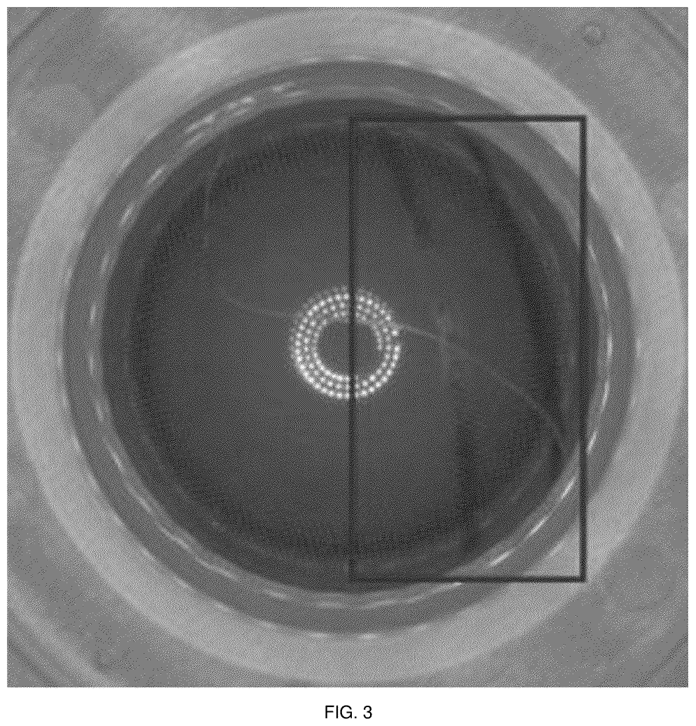

FIG. 4 is a view showing an example of an off-center defect of a colored contact lens;

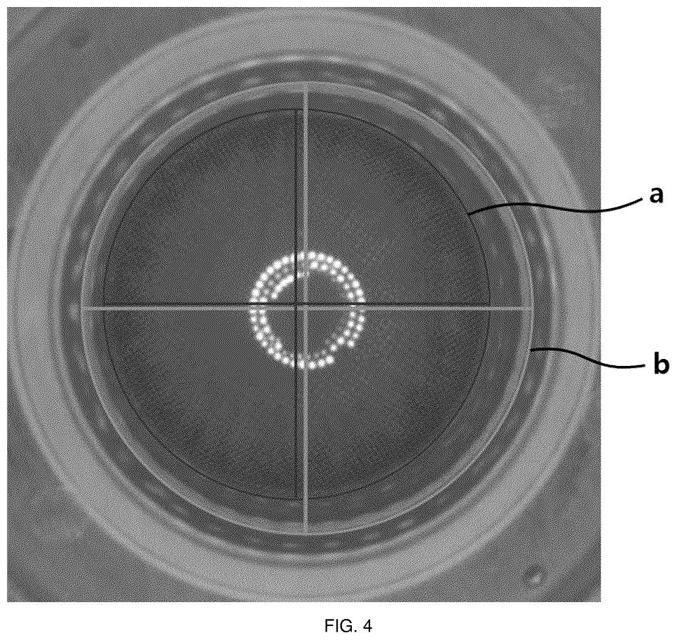

FIG. 5 is a view showing an example of a halftone dot defect in a colored contact lens;

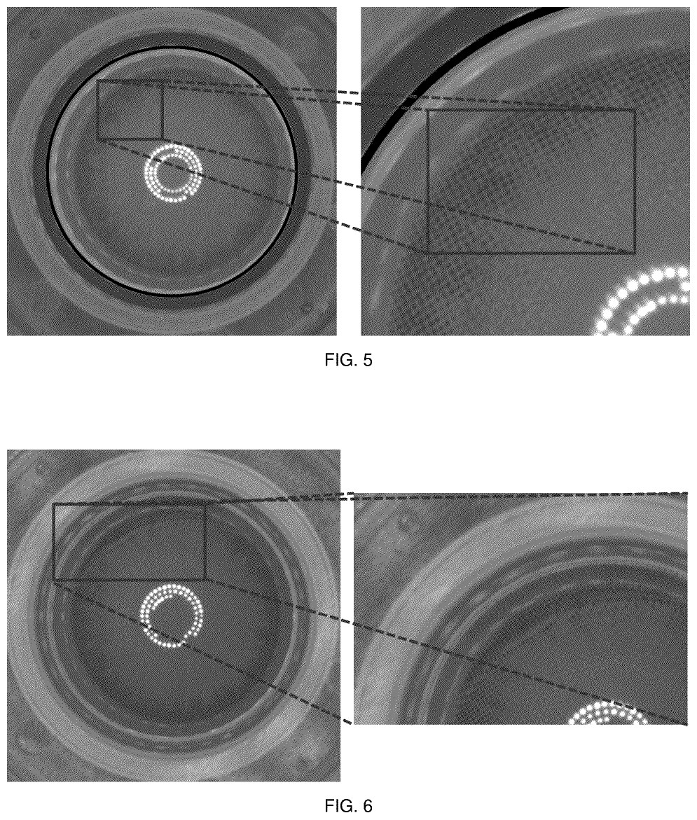

FIG. 6 is a view showing an example of cosmetic cutting of a colored contact lens;

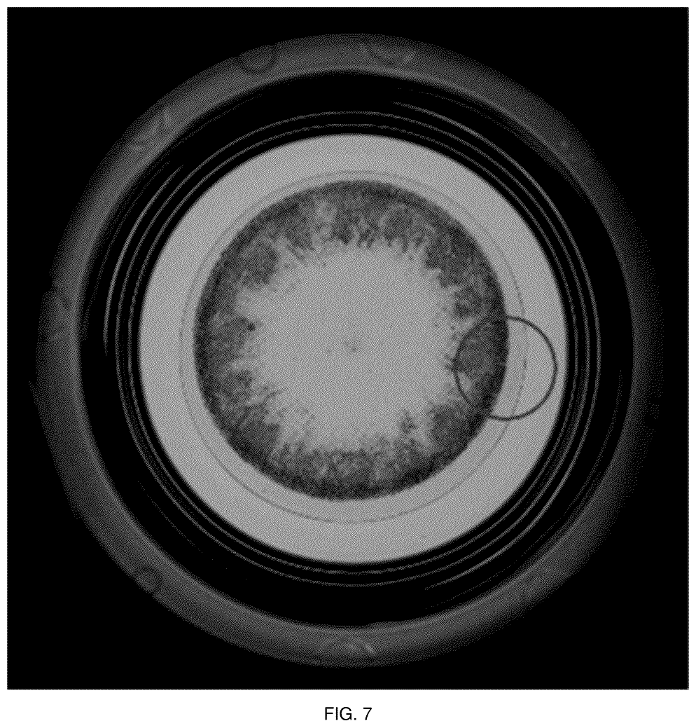

FIG. 7 is a view showing an example of a non-molding defect of a colored contact lens;

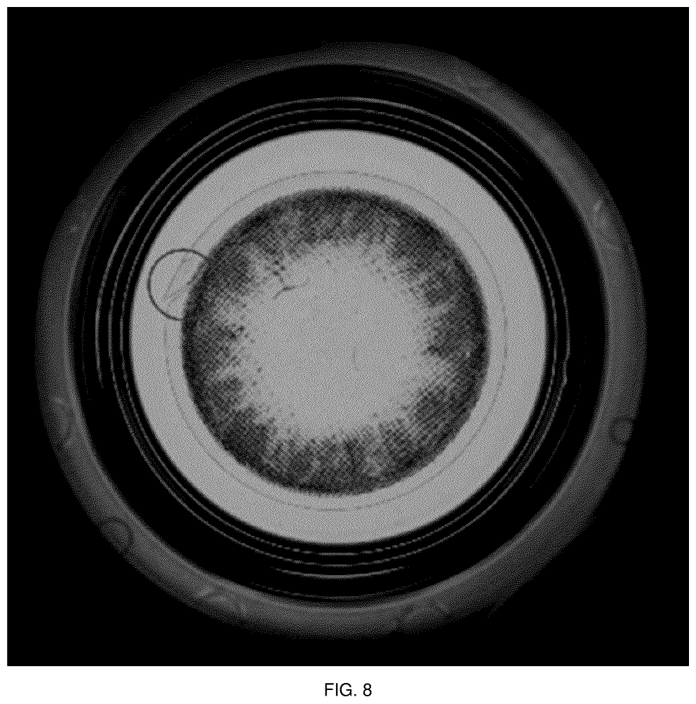

FIG. 8 is a view showing an example of a crack defect in a colored contact lens;

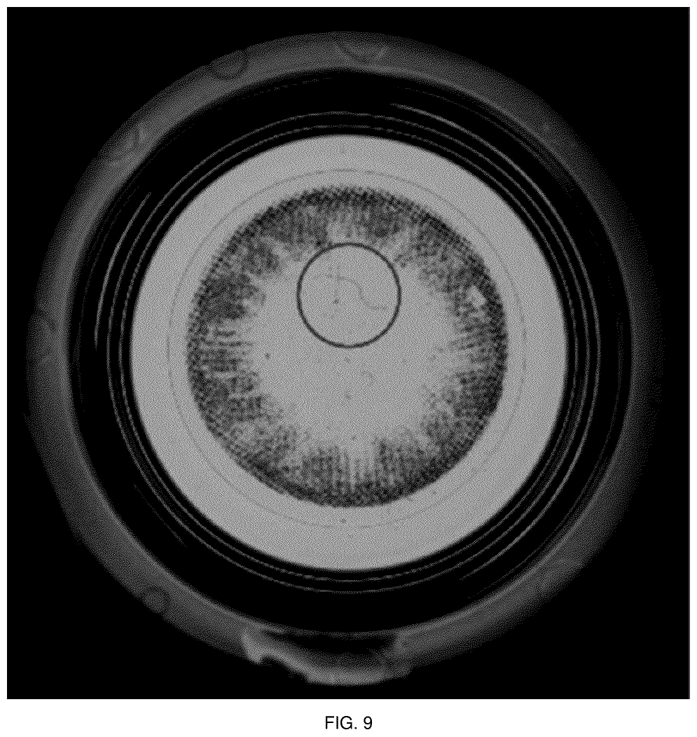

FIG. 9 is a view showing an example of a foreign matter defect in a colored contact lens;

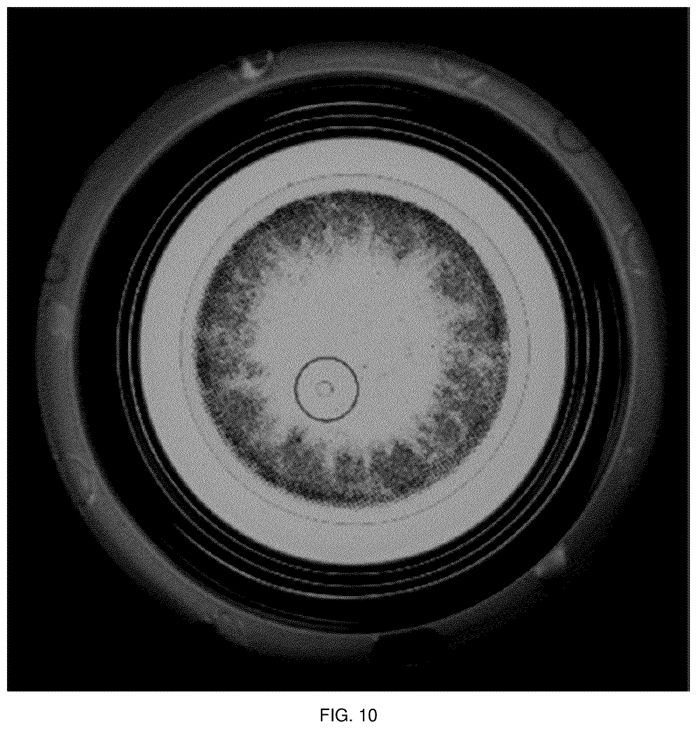

FIG. 10 is a view showing an example of a bubble defect in a colored contact lens;

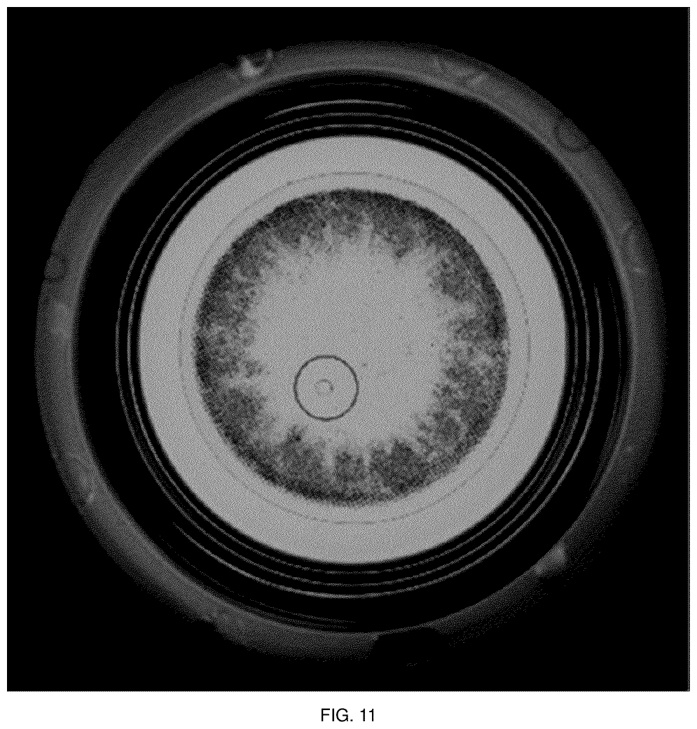

FIG. 11 is a view showing an example of a dust defect in a colored contact lens;

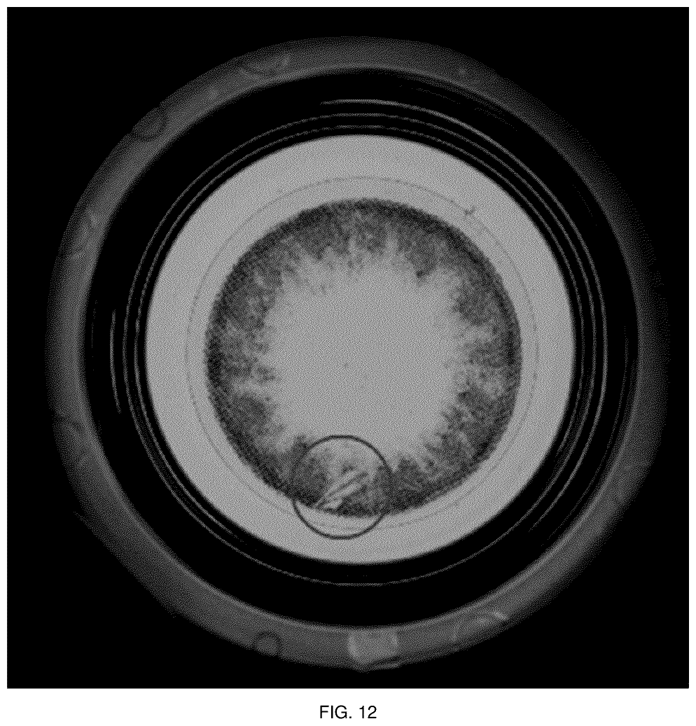

FIG. 12 is a view showing an example of a printing defect in a colored contact lens;

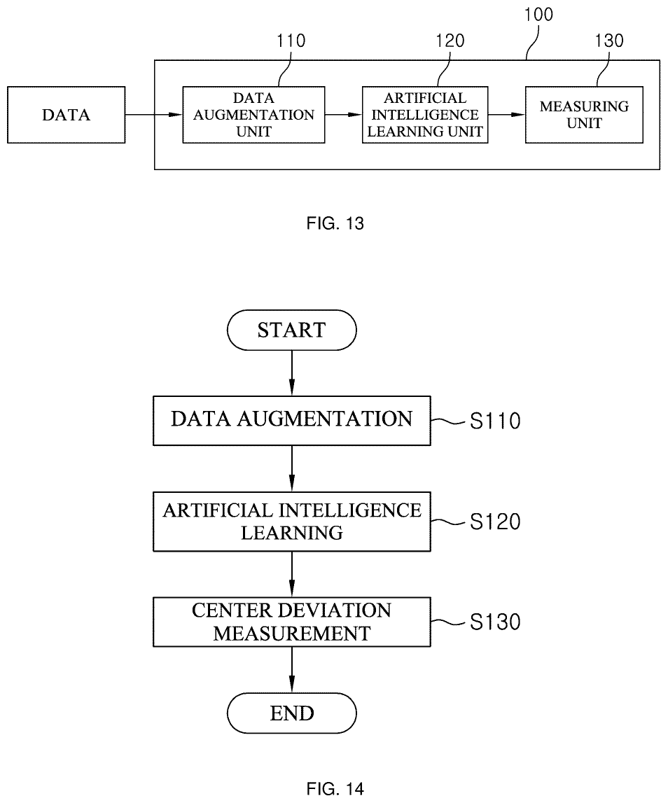

FIG. 13 is a block diagram schematically showing a configuration of an apparatus for measuring a center deviation of a contact lens according to an exemplary embodiment of the present disclosure;

FIG. 14 is a flowchart showing a method for measuring a center deviation of a contact lens according to an exemplary embodiment of the present disclosure;

FIG. 15 is a view conceptually showing an overall flow of the method for measuring a center deviation of a contact lens according to an exemplary embodiment of the present disclosure;

FIG. 16 is a view showing a diffusion process and a reverse diffusion process of a denoising diffusion probabilistic model (DDPM);

FIG. 17 is a view showing an example of the diffusion process in the DDPM;

FIG. 18 is a view showing an example of a training process through U-Net in the DDPM;

FIG. 19 a view showing an overall structure of AC-YOLO suggested in the present disclosure;
(a) of FIG. 20 is a view showing a convolution module of the existing YOLO, and (b) of FIG. 20 is a view showing an asymmetric convolutional neural network (asymmetric CNN (AC-CNN)) suggested by the present disclosure;
(a) and (b) of FIG. 21 are views for comparing an asymmetric convolutional neural network (AC-CNN) kernel and a standard CNN kernel when passing through a center point of an object;

FIG. 22 is a chart for summarizing an experimental environment for DDPM model training in an experiment of the present disclosure;

FIG. 23 is a chart for summarizing an experimental environment for YOLO model training in an experiment of the present disclosure;

FIG. 24 is a chart for summarizing a configuration of DDPM training data in the experiment of the present disclosure;

FIG. 25 is an image of data augmented through the DDPM in the experiment of the present disclosure;

FIG. 26 is a view showing data distribution of an augmented image in the experiment of the present disclosure;

FIG. 27 is a table for summarizing a data configuration for AC-YOLO learning in the experiment of the present disclosure;

FIG. 28 is a diagram for summarizing a configuration of a dataset augmented by an existing method in the experiment of the present disclosure;
(a) and (b) of FIG. 29 are graphs showing a data loss in learning using data augmented by an existing augmentation method and data augmented by the DDPM in the experiment of the present disclosure;

FIG. 30 is a chart showing lowest data loss results in learning using data augmented by an existing augmentation method and data augmented by the DDPM in the experiment of the present disclosure;

FIG. 31 is a chart showing the number of weights for each comparison model in the experiment of the present disclosure;

FIG. 32 shows results when an average loss is lowest in a training process for each model in the experiment of the present disclosure;
(a) of FIG. 33 shows a difference in center coordinates of the CA and the FA in actual areas and (b) of FIG. 33 shows a difference in center coordinates of the CA and the FA in predicted areas in the experiment of the present disclosure; and

FIG. 34 shows the lowest mean center points error (MCPsE) results for each learning model in the experiment of the present disclosure.

### DETAILED DESCRIPTION

It is to be understood that the present disclosure may be variously modified and embodied, and thus particular embodiments thereof will be illustrated in the drawings and described in detail. However, this is not intended to limit the present disclosure to the specific exemplary embodiments, it should be understood to include all modifications, equivalents, and substitutes included in the spirit and scope of the present disclosure.

The terms used in the present application are merely provided to describe specific exemplary embodiments, and are not intended to limit the present disclosure. The singular forms, “a”, “an”, and “the” are intended to include the plural forms as well, unless the context clearly indicates otherwise. In the present application, it will be further understood that the terms “include” and/or “having”, when used in this specification, specify the presence of stated features, numbers, steps, operations, elements, components, or combinations thereof, but do not preclude the presence or addition of one or more other features, numbers, steps, operations, elements, components, or combinations thereof.

Unless otherwise defined, all terms used herein, including technical or scientific terms, have the same meaning as commonly understood by those of ordinary skill in the art to which the exemplary embodiments of the present disclosure pertain. Terms, such as those defined in commonly used dictionaries, should be interpreted as having a meaning that is consistent with their meaning in the context of the related art and will not be interpreted in an idealized or overly formal sense unless expressly so defined herein.

In addition, in the description with reference to the accompanying drawings, identical components are denoted by the same reference numerals regardless of figure signs, and redundant descriptions thereof will be omitted. In describing the present disclosure, when it is determined that the detailed description of the known technology related to the present disclosure may unnecessarily obscure the subject matter of the present disclosure, the detailed description thereof will be omitted.

The present disclosure focuses on detection and measurement of an off-center defect and intends to improve contact lens product quality and production efficiency through the detection and measurement.

First, in the present disclosure, it is intended to measure the center deviation (CD) beyond simple determination of defects. This makes it possible to adjust printing equipment, thereby optimizing a production process.

Further, in the present disclosure, a high-precision standard is set to determine a contact lens as defective when the deviation distance from the center point is equal to or more than 0.4 mm (about 1.9% of the diameter) compared to the overall diameter of 21 mm. This is essential for precise quality control of contact lenses.

In addition, in the present disclosure, in order to respond to various lens types, a method capable of quickly responding to various lens types using limited data is sought.

In addition, in the present disclosure, fast and efficient defect detection may be achieved even with limited computing resources. A system presented in the present disclosure has to be able to process one image within 0.3 seconds, which contributes to real-time inspection and quick decision-making.

The present disclosure relates to an apparatus for measuring a center deviation of a contact lens, the apparatus including a data augmentation unit configured to augment original contact lens image data photographed during a contact lens manufacturing process, an artificial intelligence learning unit configured to use dataset augmented by the data augmentation unit as an input to conduct learning through an artificial intelligence learning model, and detect a center point of a colored area and a center point of a frame area of the contact lens through learning, and a measuring unit configured to measure the center deviation using the center point of the colored area and the center point of the frame area detected through the artificial intelligence learning model in the artificial intelligence learning unit.

The data augmentation unit may augment the original contact lens image data using a diffusion model.

The data augmentation unit may augment the original contact lens image data using a denoising diffusion probabilistic model (DDPM).

The artificial intelligence learning unit may proceed with learning using an object detection model.

The artificial intelligence learning unit may conduct learning using an asymmetric convolution-you only look once (AC-YOLO) model that applies an asymmetric convolutional neural network.

In a computer-readable recording medium storing a program for executing a method for measuring a center deviation of a contact lens on a computer, the method includes a data augmentation step of augmenting original contact lens image data photographed during a contact lens manufacturing process, an artificial intelligence learning step of using a dataset augmented in the data augmentation step as an input to learn through an artificial intelligence learning model and detecting a center point of a colored area and a center point of a frame area of the contact lens through learning, and a measurement step of measuring the center deviation using the center point of the colored area and the center point of the frame area detected through the artificial intelligence learning model in the artificial intelligence learning step.

In the data augmentation step, the original contact lens image data may be augmented using a diffusion model. In the data augmentation step, the original contact lens image data may be augmented using a denoising diffusion probabilistic model (DDPM).

The artificial intelligence learning step, learning may be conducted using an object detection model. In the artificial intelligence learning step, learning may be conducted using an asymmetric convolution-you only look once (AC-YOLO) model that applies an asymmetric convolutional neural network.

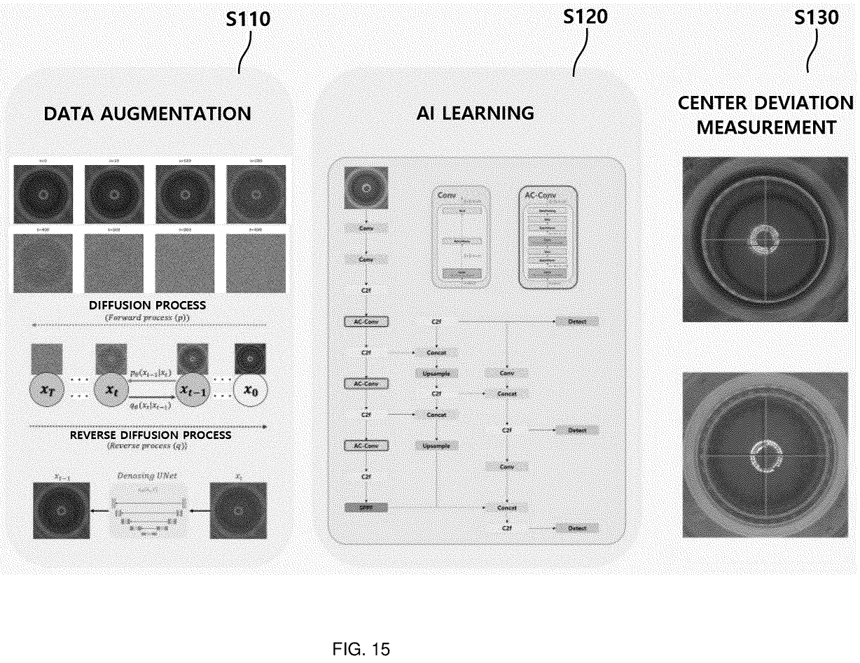

FIG. 13 is a block diagram schematically showing a configuration of an apparatus for measuring a center deviation of a contact lens according to an exemplary embodiment of the present disclosure.

Referring to FIG. 13, the apparatus for measuring a center deviation of a contact lens according to an exemplary embodiment of the present disclosure includes a data augmentation unit 110, an artificial intelligence learning unit 120, and a measuring unit 130.

The data augmentation unit 110 augments original contact lens image data using a diffusion model.

Since existing augmentation methods have limitations for fixed patterns, in the present disclosure, the data augmentation unit 110 augments contact lens data using the diffusion model.

In the present disclosure, the data augmentation unit 110 augments the data utilizing brightness change and image rotation processing of a portion of an original contact lens dataset, and then uses the denoising diffusion probabilistic model (DDPM), which is the diffusion model, to finally augment the dataset. The dataset generated through the process contains high diversity and rich information, which greatly improves the expressiveness of data compared to existing methods. In addition, by presenting in-depth analysis of generalization performance during deep learning between the characteristics of the dataset generated through DDPM and the original dataset, the effectiveness of the augmentation method is further demonstrated. The final augmented dataset and the dataset used for DDPM training are used as a training dataset of the present disclosure, and original dataset not used for learning is set as a validation dataset.

The artificial intelligence learning unit 120 uses a dataset augmented by the data augmentation unit 110 as an input to conduct learning through an artificial intelligence learning model and detects a center point of a colored area and a center point of a frame area of the contact lens through learning.

In an exemplary embodiment of the present disclosure, the artificial intelligence learning unit 120 may conduct learning using an object detection model. The artificial intelligence learning unit 120 may conduct learning using an asymmetric convolution-you only look once (AC-YOLO) model that applies an asymmetric convolutional neural network among object detection models.

The measuring unit 130 measures the center deviation using the center point of the colored area and the center point of the frame area detected through the artificial intelligence learning model in the artificial intelligence learning unit 120.

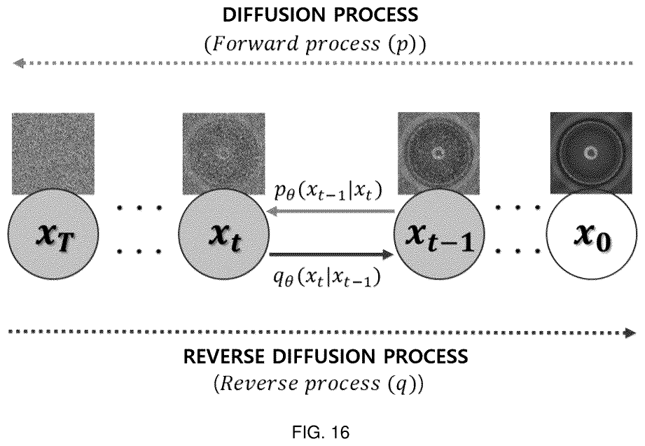

FIG. 14 is a flowchart showing a method for measuring a center deviation of a contact lens according to an exemplary embodiment of the present disclosure.

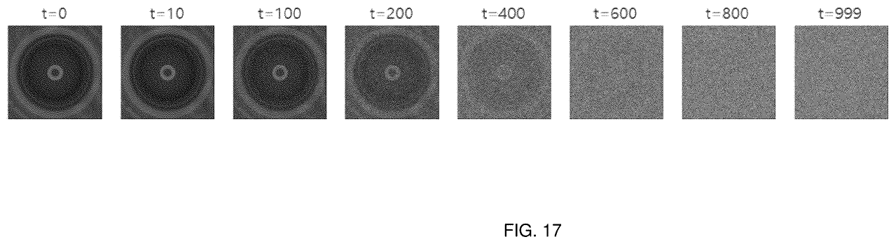

FIG. 15 is a view conceptually showing an overall flow of the method for measuring a center deviation of a contact lens according to an exemplary embodiment of the present disclosure.

Referring to FIGS. 14 and 15, a method for measuring a center deviation of a contact lens in an apparatus for measuring a center deviation of a contact lens of the present disclosure includes a data augmentation step S110 of augmenting original contact lens image data photographed during a contact lens manufacturing process, an artificial intelligence learning step S120 of using a dataset augmented in the data augmentation step S110 as an input to conduct learning through an artificial intelligence learning model and detecting a center point of a colored area and a center point of a frame area of the contact lens through learning, and a measurement step S130 of measuring the center deviation using the center point of the colored area and the center point of the frame area detected through the artificial intelligence learning model in the artificial intelligence learning step S120.

In an exemplary embodiment of the present disclosure, in the data augmentation step S110, the original contact lens image data may be augmented using a diffusion model. More specifically, in the data augmentation step S110, the original contact lens image data may be augmented using a denoising diffusion probabilistic model (DDPM).

In an exemplary embodiment of the present disclosure, in the artificial intelligence learning step S120, learning may be conducted using an object detection model. More specifically, in the artificial intelligence learning step S120, learning may be conducted using an asymmetric convolution-you only look once (AC-YOLO) model that applies an asymmetric convolutional neural network.

In the present disclosure, it is intended to augment data that deviates from a fixed pattern using the DDPM, one of the diffusion models, beyond traditional data augmentation methods such as brightness change, image rotation, or the like.

The DDPM is a deep learning-based generative model for modeling a stochastic process of generating data, and one of the characteristics of the model is that the method gradually generates data. For this reason, the model provides superior performance compared to a generative adversarial network (GAN), which directly generates images in a high-dimensional data space.

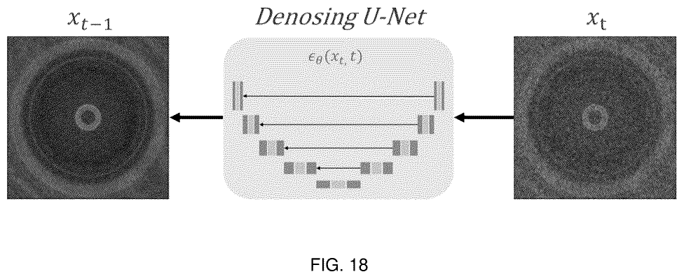

FIG. 16 is a view showing a diffusion process and a reverse diffusion process of a DDPM.

Referring to FIG. 16, the DDPM is divided into two stages: a diffusion process and a reverse diffusion process.

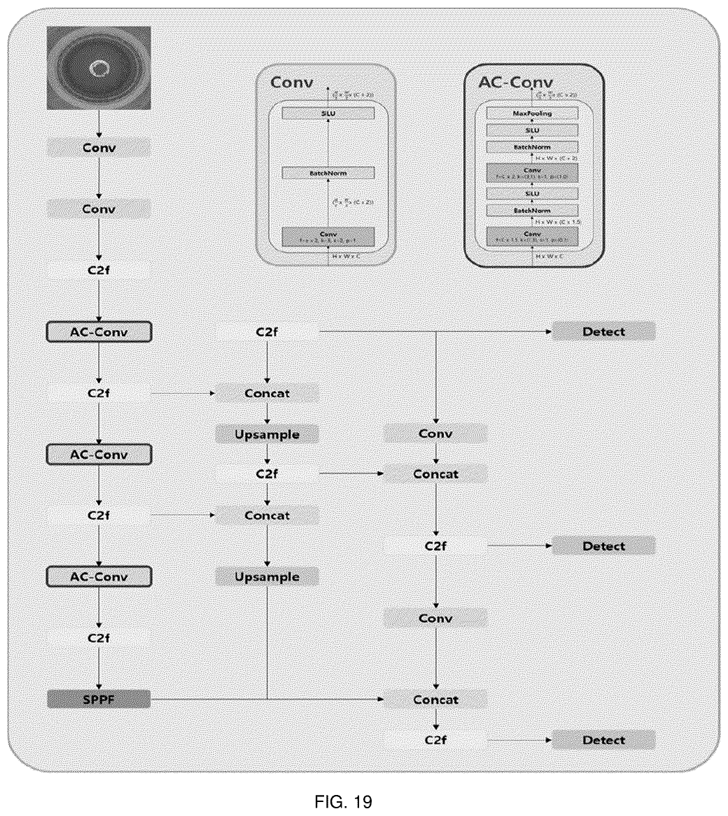

FIG. 17 is a view showing an example of the diffusion process in the DDPM.

As shown in FIG. 17, the diffusion process in the DDPM gradually adds noise from original data X₀ through each time step t to a final time step (T=1000). The diffusion process follows a Markov chain as shown in the following equation.

$${x}_{t} = \sqrt{1 - β} {x}_{t - 1} + \sqrt{{β}_{t}} ϵ \qquad ( 2 )$$

Here, ε is noise extracted from a standard normal distribution, and β₁ is a coefficient that determines a noise level.

The reverse diffusion process is a process of recovering from time t to time t-1, and follows the following equation.

$${x}_{t - 1} = \frac{1}{\sqrt{1 - {β}_{t}}} ( {x}_{t} - \frac{{β}_{t}}{\sqrt{1 - {\sum }_{s = 1}^{t} {β}_{s}}} {ϵ}_{θ} ( {x}_{t} , t ) ) \qquad ( 3 )$$

Here, ε_{θ}(Xₜ, t) is the noise estimated through the trained neural network. The core of the DDPM is to predict noise ε using a neural network in the reverse diffusion process. In this way, learning the process of getting closer and closer to the original data X₀ is performed.

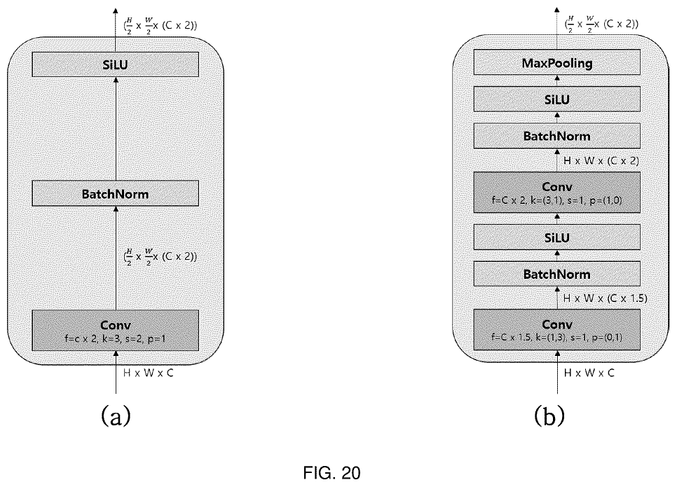

FIG. 18 is a view showing an example of a training process through U-Net in the DDPM.

As shown in FIG. 18, training may be performed based on U-Net during the reverse diffusion process of the DDPM.

In the DDPM, a loss function based on a Variational Lower Bound (ELBO) is mainly used. The loss function helps minimize a difference between the distribution of data Xₜ generated from the model's original data X₀ and the actual data distribution. The loss function L(θ) used in the DDPM has the following equation.

$$L ( θ ) = {𝔼}_{0 , \text{?} ∼ 𝒩 ( 0 , \text{?} )} [ {\sum }_{t = 1}^{T} {λ}_{t} {‖ ϵ - {ϵ}_{θ} ( {x}_{t} , t ) ‖}^{2} ] \qquad ( 4 )$$

$$\text{?} \text{indicates text missing or illegible when filed}$$

In equation (4), θ represents a parameter of the model, ε represents noise extracted from the standard normal distribution, ε_{θ}(Xₜ, t) represents noise estimated by the neural network at time step t, and λₜ represents a weight for each time step.

The DDPM is different from traditional data augmentation methods. Traditional methods increase the diversity of the dataset by adjusting the brightness, rotation, or the like, of an image, whereas the DDPM gradually adds noise to original data and traces it backwards to generate a more sophisticated image from the noise. This allows the deep learning model to augment more complex data patterns, ultimately augmenting data of various patterns.

In the present disclosure, the CD is to be measured by detecting the center coordinates of the CA and FA of a contact lens based on you-only-look-once (YOLO), one of the object detection deep learning models.

YOLO is a deep learning-based algorithm for real-time object detection. YOLO detects and classifies multiple objects by looking at an entire image only once. Unlike traditional object detection methods, the model processes the entire image through a single neural network without a separate area proposal step, divides the image into an S*S grid, and predicts a bounding box in each cell and a corresponding confidence score and conditional class probability.

Each bounding box is used to predict the location and size of an object. The location of the bounding box is expressed as (x, y) and the size thereof is (w, h), which are predicted by the neural network. An error between the actual box and the predicted box may be expressed as follows.

$${Loss}_{coords} = {\sum }_{i = 0}^{{S}^{2}} {\sum }_{j = 0}^{B} {\text{?}}_{ij}^{obj} [ {( {x}_{i} - {\hat{x}}_{i} )}^{2} + {( {y}_{i} - {\hat{y}}_{i} )}^{2} + {( {w}_{i} - {\hat{w}}_{i} )}^{2} + {( {h}_{i} - {\hat{h}}_{i} )}^{2} ] \qquad ( 5 )$$

$$\text{?} \text{indicates text missing or illegible when filed}$$

Here, is 1 when the object is present in the j-th bounding box of the i-th cell, otherwise 0.

The confidence score of each bounding box is calculated as the product of the probability that the box contains the object and the Intersection over Union (IOU). This may be expressed with the following equation.

$$Confidence = Pr ( Object ) * {IOU}_{pred}^{truth} \qquad ( 6 )$$

The conditional class probability represents the probability that a grid cell contains an object of a specific class, and is expressed by the following expression.

P(Classᵢ|Object) (7)

In addition, YOLO considers class specific confidence. This is the product of the probability that an object belongs to a specific class, the probability that the object is present, and the IOU of the corresponding box, as shown in the following equation.

$$Class Specific Confidence = Pr ( {Class}_{i} \vert Object ) * Pr ( Object ) * {IOU}_{pred}^{truth} \qquad ( 8 )$$

A loss function of YOLO comprehensively considers a location error, a confidence score error, and a class prediction error. To minimize the errors, the model is trained to detect objects of various sizes and types and predict their accurate position and class.

The YOLO has a clear advantage in detecting the center coordinates of the CA and FA and measuring the CD compared to the previously used method of applying the Hough circle detection algorithm after semantic segmentation.

First, YOLO provides area-based detection. Semantic segmentation classifies a class for each pixel, but object detection uses anchor boxes to classify a specific area in the image. This is advantageous in identifying the exact location and size of an object, and as a result, the center coordinates of the object may be detected more accurately.

Second, YOLO provides instance distinction of an object. Semantic segmentation is advantageous in identifying the outline of an object, but does not distinguish between individual object instances. On the other hand, object detection may individually identify each object and individually find their center coordinates.

Third, YOLO has an advantage in the amount of computation. Object detection may be computationally more efficient than semantic segmentation since the object detection targets and processes only objects of interest in the entire image. Since semantic segmentation requires processing of every pixel in an image, the semantic segmentation requires relatively more computational resources, especially in a high-resolution image.

Fourth, YOLO is flexible for various object sizes. Object detection models may detect objects of various sizes using anchor boxes of various sizes. Compared to semantic segmentation, this helps effectively detect objects of various sizes and accurately identify their center coordinates.

Last, YOLO provides an intuitive result interpretation. Object detection may intuitively show the location of an object through a bounding box, which provides an intuitive and clear way in finding the center coordinates. The semantic segmentation result shows the exact boundary of the object, but additional calculations such as the Hough circle detection algorithm are required to find the center coordinates. In the case of Hough circle detection conducted in existing research, when the semantic segmentation result fails to predict as a perfect circle, the accuracy of center coordinate detection decreases.

The present disclosure suggests asymmetric CNN-YOLO (AC-YOLO), which applies the asymmetric CNN to the YOLO network structure.

The CNN has an excellent ability to recognize local patterns in images, through which the CNN extracts features such as edges, texture, and color of an image. In the CNN, a kernel size plays an important role. The CNN consists of several layers that are essential for extracting and understanding image features, and among the layers, the CNN layer uses filters (kernels) of various sizes and shapes to identify image features.

In general, the kernels used in the CNN have square shapes such as (3×3) and (5×5), but these days, the use of asymmetric kernels such as (1×3) and (3×1) also receives attention. The asymmetric kernel is useful for better capturing a specific orientation in an image. For example, a kernel of size (1×3) is suitable for detecting horizontal features of an image, while a kernel of size (3×1) better captures vertical features.

The asymmetric kernels are especially useful when directionality is an important factor in the image. For example, the kernels may be effective when detecting road lines or analyzing a vertical structure of a building. By covering a wide range in one direction and intensively analyzing a narrow range in other directions, the kernels may better capture details in a particular direction.

The use of the asymmetric kernel improves the computational efficiency of the model and enables more specialized feature extraction. This helps better understand different aspects of an image and make more accurate predictions for specific tasks. Therefore, when designing the CNN, it is very important to select the size and shape of the kernel.

FIG. 19 a view showing an overall structure of AC-YOLO suggested in the present disclosure.
(a) of FIG. 20 is a view showing a convolution module of the existing YOLO, and (b) of FIG. 20 is a view showing an asymmetric convolutional neural network (asymmetric CNN (AC-CNN)) suggested by the present disclosure.

Referring to FIGS. 19 and (a) and (b) of FIG. 20, AC-YOLO suggested in the present disclosure performs learning by replacing a convolutional neural network layer before a C2f layer located in a YOLOv8n backbone with an asymmetric convolutional neural network layer.

(a) and (b) of FIG. 21 are views for comparing an asymmetric convolutional neural network (AC-CNN) kernel and a standard CNN kernel when passing through a center point of an object.

(a) of FIG. 21 shows an AC-CNN kernel and (b) of FIG. 21 shows the standard CNN kernel.

As shown in (a) and (b) of FIG. 21, the reason for using the AC CNN in the present disclosure is that when continuous (1×3) and (3×1) kernels pass through the center point of an object, they may focus on the center point rather than a (3×3) kernel area to extract features. This uses the principle that the kernel size is defined as a probability space, and when passing through the center point of an object, the probability of the center point in the probability space increases as the size of the kernel becomes smaller.

In addition, since the asymmetric CNN does not work well in early layers and is better applied after extracting some features, the asymmetric CNN is not applied to early layers.

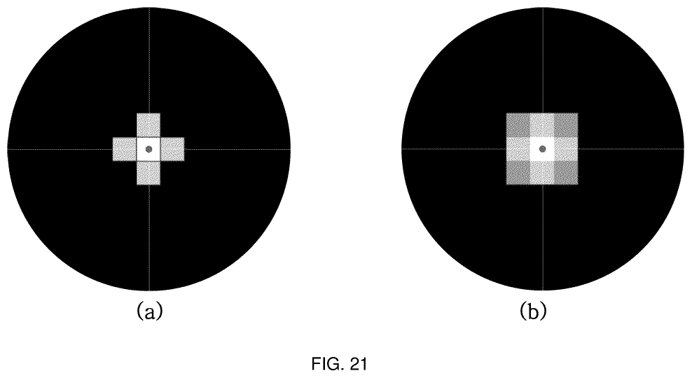

FIG. 22 is a chart for summarizing an experimental environment for DDPM training in an experiment of the present disclosure.

As shown in FIG. 22, the DDPM uses high-end computing resources capable of high-performance parallel GPU processing since the number of model weights is large.

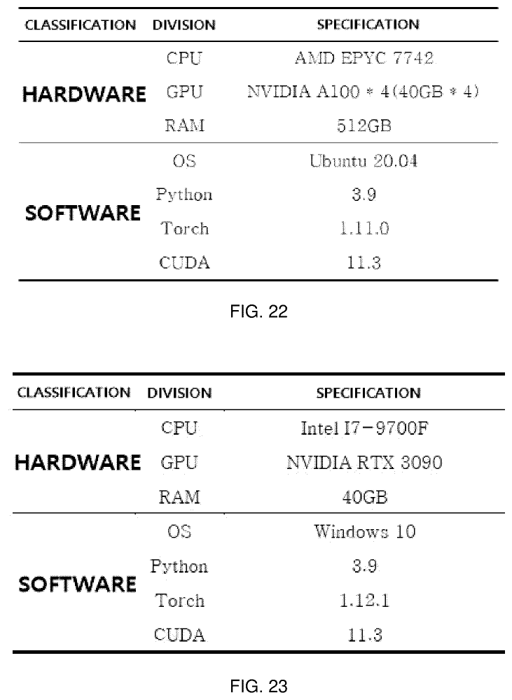

FIG. 23 is a chart for summarizing an experimental environment for YOLO model training in an experiment of the present disclosure.

As shown in FIG. 23, the YOLO model generally utilizes a random seed to ensure reproducibility since the number of model weights is not large, and uses the computing resources of a single GPU.

In the existing method, the original dataset was augmented using traditional methods to compensate for the insufficient number of pieces of data. The augmentation method may have a risk of overfitting due to the fixed pattern. To solve the risk, in the experiment of the present disclosure, data is augmented using the DDPM.

The dataset for DDPM training was sampled for each lens type to prevent augmentation from being biased towards a specific lens type. The sampling method is as follows.

An original data set Oᵢ for lens type i includes oᵢ pieces of data, which is expressed as follows.

$${O}_{i} = {\{ {x}_{i , j} \}}_{j = 1}^{{o}_{i}} \\ {data}_{o} = {( {O}_{i} )}_{\text{?}} I = \{ 1 , 2 , 3 , … , 12 \} \qquad ( 9 )$$

$$\text{?} \text{indicates text missing or illegible when filed}$$

From this set, K indices y are selected according to a discrete uniform probability distribution. K is 10 when oᵢ is over 10, otherwise it is oᵢ. The selected index set is expressed as follows.

$${\{ {y}_{ik} \}}_{k = 1}^{K} ∼ Uniform \{ 1 , 2 , … , {o}_{i} \} ( if , {o}_{i} > 10 then K = 10 , else L = {o}_{i} ) \qquad ( 10 )$$

Sᵢ is constructed by sampling data from oᵢ located at the selected index **. This is expressed as follows.

$${S}_{i} = {\{ {x}_{i , y \text{?}} \}}_{k = 1}^{K} \\ {data}_{S} = {( {S}_{i} )}_{\text{?}} , I = \{ 1 , 2 , 3 , … , 12 \} \qquad ( 11 )$$

$$\text{?} \text{indicates text missing or illegible when filed}$$

In the experiment of the present disclosure, o₃=6 in dataₒ, and oᵢ>10 for the remaining i. The total number of extracted pieces of sampling data may be obtained as follows, and in this dataset, the total number is 116 according to the following expression.

$${\sum }_{i = 1}^{I} ( n ( {S}_{i} ) ) \qquad ( 12 )$$

Then, all lens types i in Sᵢ are augmented to 50 each through Algorithm 1. In the experiment of the present disclosure, a total of 600 DDPM training datasets are built by applying Algorithm 1 to all i. This is calculated with the following expression.

$${\sum }_{i = 1}^{I} ( n ( Algorithm 1 ( {S}_{i} ) ) \qquad ( 13 )$$

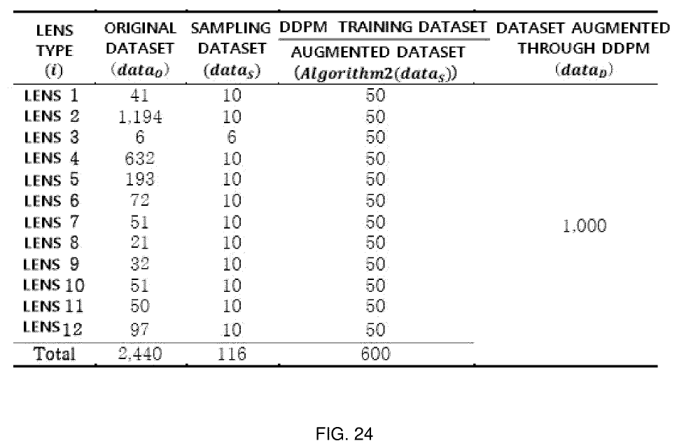

FIG. 24 is a chart for summarizing a configuration of DDPM training data in the experiment of the present disclosure.

In FIG. 24, a set of data augmented by the DDPM is expressed as data_{D}, and the size of the image is 400×400.

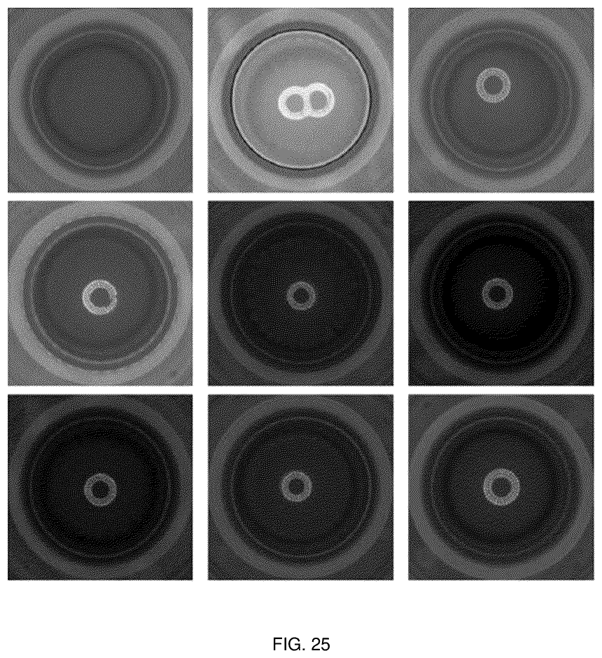

FIG. 25 is an image of data augmented through the DDPM in the experiment of the present disclosure.

Referring to FIG. 25, the dataset augmented through the DDPM was augmented with a similar pattern overall depending on the lens type, but various changes were observed, such as loss of lens illumination, additional generation, off-centering, and slight deformation of the lens pattern.

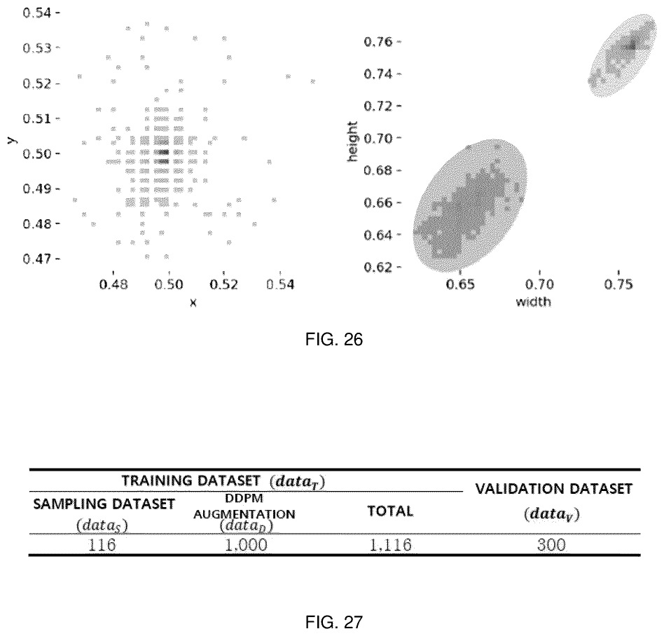

FIG. 26 is a view showing data distribution of an augmented image in the experiment of the present disclosure.

In FIG. 26, a left image shows the distribution of the center point, and a right image shows the distribution of height and width. In the right image, a lower left area shows a colored area (CA) distribution, and a upper right area shows a frame area (FA) distribution.

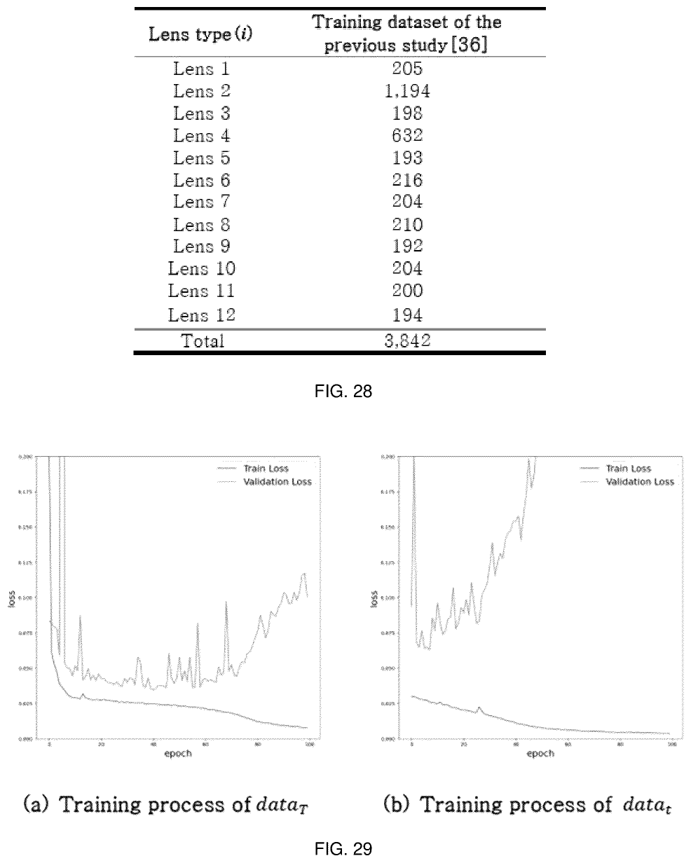

FIG. 27 is a table for summarizing a data configuration for AC-YOLO learning in the experiment of the present disclosure.

As shown in FIG. 27, a total of 1,116 pieces of image data, including 1,000 pieces of data_{D} and 116 pieces of sample dataₛₛ augmented through the DDPM are contained as training data data_{T} of AC-YOLO. A validation dataset dataᵥ includes 300 datasets not used in DDPM training, of which there are 180 lens types with unlearned patterns.

In the experiment of the present disclosure, the generalization of data_{T} augmented through the diffusion model and dataₜ augmented by the existing method are verified in dataᵥ to test which dataset may prevent overfitting relatively better.

FIG. 28 is a diagram for summarizing a configuration of a dataset augmented by an existing method in the experiment of the present disclosure.

FIG. 28 shows an example of a dataset configuration of dataₜ.

In the experiment of the present disclosure, a DeepLabV3+ model is trained using dataₜ augmented by the existing augmentation method and data_{T} augmented by the DDPM, and comparative evaluation is performed in dataᵥ. All image sizes are adjusted to 416×416.

(a) and (b) of FIG. 29 are graphs showing a data loss in learning using data augmented by an existing augmentation method and data augmented by the DDPM in the experiment of the present disclosure.

(a) and (b) of FIG. 29 show the loss of dataᵥ with epochs when data_{T} and dataₜ are each used as training data, where (a) shows the DDPM method, and (b) shows the existing augmentation method.

As shown in (a) and (b) of FIG. 29, the loss of dataᵥ was lower for data_{T} than for dataₜ, and the divergence of the loss of dataᵥ with epochs slowly progressed.

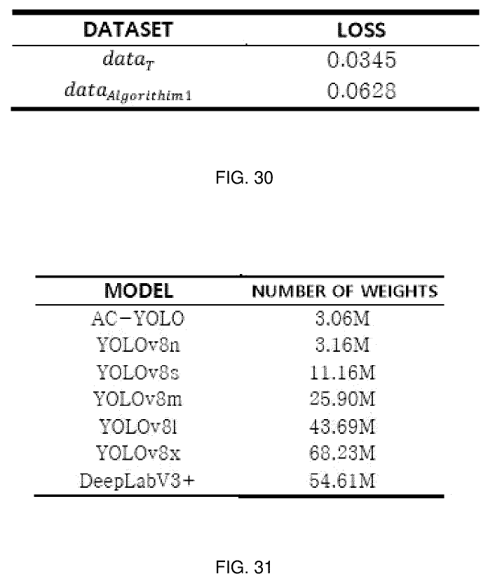

FIG. 30 is a chart showing lowest data loss results in learning using data augmented by an existing augmentation method and data augmented by the DDPM in the experiment of the present disclosure.

It can be seen that data_{T} augmented through the DDPM in this way may be effective in preventing overfitting to fixed printing patterns, even though the number of pieces of data_{T} is smaller than the number of pieces of dataₜ augmented with the existing augmentation method. This means that the DDPM augmentation method improves data diversity and allows the model to perform more generalized learning. In the experiment of the present disclosure, a process of learning and evaluating data_{T}, which has the effect of preventing overfitting, is conducted in AC-YOLO.

In the experiment of the present disclosure, the CD is measured using AC-YOLO and its performance is compared with performance of existing methods and various object detection models. In this experiment, the image size of the training and validation datasets was adjusted to 416×416, and each YOLO model was trained for 1000 epochs. The number of weights for each model is as follows.

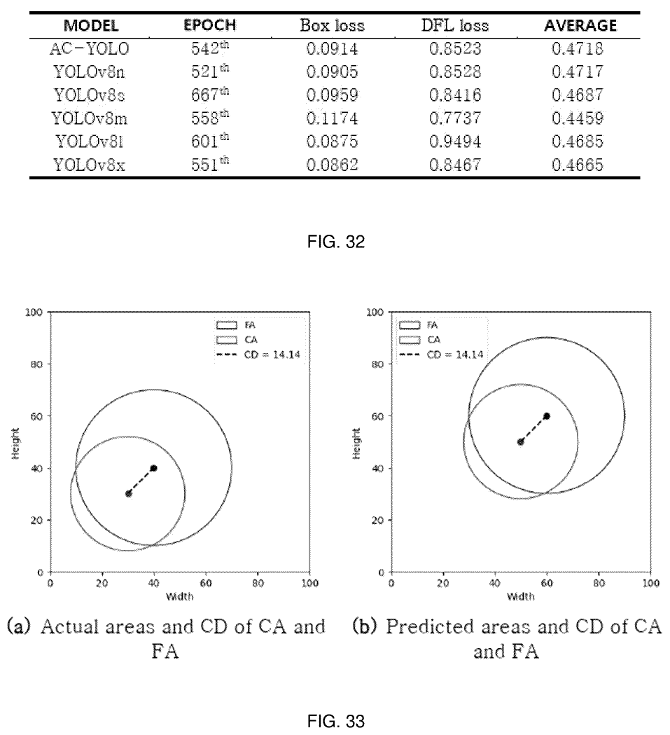

FIG. 31 is a chart showing the number of weights for each comparison model in the experiment of the present disclosure.

FIG. 32 shows results when an average loss is lowest in a training process for each model in the experiment of the present disclosure.

As shown in FIG. 32, AC-YOLO suggested in the present disclosure has higher box loss and DFL loss than existing YOLOs. This is because the loss function of YOLO is calculated based on IOU, where both height and width are considered. However, in the present disclosure, since the height and width are not considered and only the exact center coordinates of the object are needed, YOLO loss and CD are not necessary and sufficient conditions.

(a) of FIG. 33 shows a difference in center coordinates of the CA and the FA in actual areas and (b) of FIG. 33 shows a difference in center coordinates of the CA and the FA in predicted areas in the experiment of the present disclosure.

Referring to FIG. 33, a difference between the predicted center coordinates of the CA and FA and the actual center coordinates of the CA and FA may be large, but when the CA and FA are predicted to be in the same direction and distance, CDₓ and CD_{y} may be accurately measured.

Therefore, in the present disclosure, the center coordinate errors of each of the CA and FA, as well as the CD, are considered and evaluated together.

When defining the center coordinates of the CA and FA as (x_{CA}, y_{CA}) and (x_{FA}, y_{FA}), respectively, the predicted value as \hat{ }(hat), and the number of validation data as v, each axis error of each center coordinate (center mean absolute error of axis in area (MAE_{(axis, area)})) is defined by the following equation.

$${MAE}_{x , CA} = \frac{1}{v} {\sum }_{i = 1}^{v} \vert {x}_{i , CA} - {\hat{x}}_{i , CA} \vert \\ {MAE}_{x , FA} = \frac{1}{v} {\sum }_{i = 1}^{v} \vert {x}_{i , FA} - {\hat{x}}_{i , FA} \vert \\ {MAE}_{y , CA} = \frac{1}{v} {\sum }_{i = 1}^{v} \vert {y}_{i , CA} - {\hat{y}}_{i , CA} \vert \\ {MAE}_{y , FA} = \frac{1}{v} {\sum }_{i = 1}^{v} \vert {y}_{i , FA} - {\hat{y}}_{i , FA} \vert \qquad ( 14 )$$

In addition, the CD error (mean center deviation error (MCDE)) is defined as the average of the Euclidean distance differences as shown in the following equation.

$$MCDE = \frac{1}{v} {\sum }_{i = 1}^{v} \sqrt{{( {x}_{CA , i} - {x}_{FA , i} )}^{2} + {( {x}_{CA , i} - {y}_{FA , i} )}^{2}} - \sqrt{{( {\hat{x}}_{CA , i} - {\hat{x}}_{FA , i} )}^{2} + {( {\hat{y}}_{CA , i} - {\hat{y}}_{FA , i} )}^{2}} \qquad ( 15 )$$

In the present disclosure, a case in which the mean center points error (MCPsE) is lowest during the learning process is defined as the best model, and may be expressed by the equation below.

$$MCPsE = \frac{{MAE}_{x , CA} + {MAE}_{x , FA} + {MAE}_{y , CA} + {MAE}_{y , FA} + MCDE}{5} \qquad ( 16 )$$

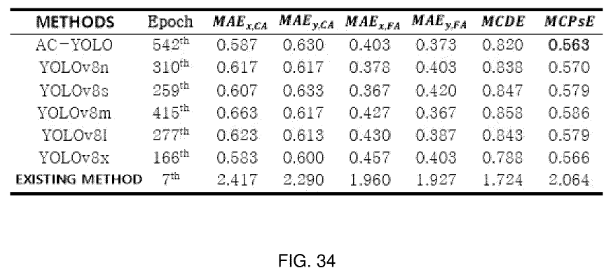

FIG. 34 shows the lowest mean center points error (MCPsE) results for each learning model in the experiment of the present disclosure.

As shown in FIG. 34, the AC-YOLO suggested in the present disclosure shows superior results than the existing method in predicting the coordinates of the center points of the CA and the FA and the CD. This proves that CD measurement through object detection is more effective than existing methods. In addition, it can be seen that by applying asymmetric-convolution instead of the CNN used in the existing YOLO Backbone, the center point of an object for the contact lens dataset is predicted more accurately while using fewer weights.

As described above, in the experiment of the present disclosure, a new model called AC-YOLO was suggested and verified to measure the center deviation (CD) of a contact lens. The experimental results showed that AC-YOLO has superior performance compared to existing YOLO models.

Further, the data augmentation method using the diffusion model suggested in the present disclosure was effective in preventing overfitting.

The technology suggested in the present disclosure is expected to play an important role in improving quality control, reducing defect rates, and increasing production efficiency in the contact lens manufacturing process.

Meanwhile, the method for measuring a center deviation of a contact lens according to the embodiment of the present disclosure may be implemented as a computer-readable code on a computer-readable recording medium. The computer-readable recording medium includes all types of recording devices that store data capable of being read by a computer system.

For example, the computer-readable recording medium includes a ROM, a RAM, a CD-ROM, a magnetic tape, a hard disk, a floppy disk, a removable storage device, a non-volatile memory (flash memory), an optical data storage device, or the like.

In addition, the computer-readable recording medium may be distributed to computer systems connected through a computer communication network, and stored and executed as a code capable of being read in a distributed manner.

According to the present disclosure, there is an effect of quickly and accurately detecting an off-center defect of a contact lens by measuring a center deviation of the contact lens using artificial intelligence, thereby reducing a defect rate and increasing production efficiency.

In addition, according to the present disclosure, there is an effect of contributing to innovatively improving the quality control of contact lens manufacturing, improving production efficiency, and increasing the reliability of the final product. Furthermore, it is expected that the present disclosure can be applied to defect detection and quality control in various manufacturing industries beyond the colored contact lens industry.

The present disclosure has been described above using several preferred embodiments, but the embodiments are illustrative and not limiting. Those of ordinary skill in the art to which the present disclosure pertains will understand that various changes and modifications could be made without departing from the spirit of the present disclosure and the scope of rights set forth in the appended claims.

### REFERENCE SIGNS LIST

100: Apparatus for measuring center deviation of contact lens
110: Data augmentation unit
120: Artificial intelligence learning unit
130: Measuring unit

What is claimed is:

1. An apparatus for measuring a center deviation of a contact lens, the apparatus comprising:
a data augmentation unit configured to augment original contact lens image data photographed during a contact lens manufacturing process;
an artificial intelligence learning unit configured to use dataset augmented by the data augmentation unit as an input to conduct learning through an artificial intelligence learning model, and detect a center point of a colored area and a center point of a frame area of the contact lens through learning; and
a measuring unit configured to measure the center deviation using the center point of the colored area and the center point of the frame area detected through the artificial intelligence learning model in the artificial intelligence learning unit.

2. The apparatus of claim 1, wherein the data augmentation unit augments the original contact lens image data using a diffusion model.

3. The apparatus of claim 2, wherein the data augmentation unit augments the original contact lens image data using a denoising diffusion probabilistic model (DDPM).

4. The apparatus of claim 1, wherein the artificial intelligence learning unit conducts learning using an object detection model.

5. The apparatus of claim 4, wherein the artificial intelligence learning unit conducts learning using an asymmetric convolution-you only look once (AC-YOLO) model that applies an asymmetric convolutional neural network.

6. A method for measuring a center deviation of a contact lens in an apparatus for measuring a center deviation of a contact lens, the method comprising:
a data augmentation step of augmenting original contact lens image data photographed during a contact lens manufacturing process;
an artificial intelligence learning step of using a dataset augmented in the data augmentation step as an input to conduct learning through an artificial intelligence learning model and detecting a center point of a colored area and a center point of a frame area of the contact lens through learning; and
a measurement step of measuring the center deviation using the center point of the colored area and the center point of the frame area detected through the artificial intelligence learning model in the artificial intelligence learning step.

7. The method of claim 6, wherein in the data augmentation step, the original contact lens image data is augmented using a diffusion model.

8. The method of claim 7, wherein in the data augmentation step, the original contact lens image data is augmented using a denoising diffusion probabilistic model (DDPM).

9. The method of claim 6, wherein in the artificial intelligence learning step, learning is conducted using an object detection model.

10. The method of claim 9, wherein in the artificial intelligence learning step, learning is conducted using an asymmetric convolution-you only look once (AC-YOLO) model that applies an asymmetric convolutional neural network.

11. A computer-readable recording medium storing a program for executing a method for measuring a center deviation of a contact lens on a computer, the method comprising:
a data augmentation step of augmenting original contact lens image data photographed during a contact lens manufacturing process;
an artificial intelligence learning step of using a dataset augmented in the data augmentation step as an input to conduct learning through an artificial intelligence learning model and detecting a center point of a colored area and a center point of a frame area of the contact lens through learning; and
a measurement step of measuring the center deviation using the center point of the colored area and the center point of the frame area detected through the artificial intelligence learning model in the artificial intelligence learning step.

12. The computer-readable recording medium of claim 11, wherein in the data augmentation step, the original contact lens image data is augmented using a diffusion model.

13. The computer-readable recording medium of claim 12, wherein in the data augmentation step, the original contact lens image data is augmented using a denoising diffusion probabilistic model (DDPM).

14. The computer-readable recording medium of claim 11, wherein in the artificial intelligence learning step, learning is conducted using an object detection model.

15. The computer-readable recording medium of claim 14, wherein in the artificial intelligence learning step, learning is conducted using an asymmetric convolution-you only look once (AC-YOLO) model that applies an asymmetric convolutional neural network.
